(19) United States
(12) Patent Application Publication
(10) Pub. No.: US 2014/0238007 A1
(43) Pub. Date: Aug. 28, 2014

(54) Hydraulic Ride Control System

(71) Applicant: CATERPILLAR INC., Peoria, IL (US)

(72) Inventor: Wesley T. Payne, Plainfield, IL (US)

(73) Assignee: CATERPILLAR INC., Peoria, IL (US)

(21) Appl. No.: 13/778,967

(22) Filed: Feb. 27, 2013

(51) Int. Cl. F15B 1/02

(52) U.S. Cl. CPC F15B 1/021
USPC 60/327; 60/413

(57) ABSTRACT

A hydraulic system is provided including a hydraulic actuator having a first chamber. A pump is configured to supply pressurized fluid to the hydraulic actuator. A balancing valve is configured to be operable in a balancing mode to equalize pressure in an accumulator and the first chamber of the hydraulic actuator. An activation valve is configured to be operable in a ride control mode to place the first chamber of the hydraulic actuator in communication with the accumulator. A flow control valve is configured to block flow from the pump when a flow rate from the pump exceeds a predetermined amount.

### TECHNICAL FIELD

This patent disclosure relates generally to hydraulic systems and, more particularly, to a hydraulic system having a ride control arrangement.

### BACKGROUND

Many work machines, such as, for example loaders and excavators, use hydraulic actuators coupled to a work implement, such as a bucket, to manipulate a load. When such a machine is moved with the work implement holding a load, e.g. a loaded bucket, the machine may lope or bounce when encountering rough or uneven terrain or other obstacles. The substantial inertia of the load carrying work implement can exacerbate these movements resulting in increased wear of the work machine and discomfort for the operator.

One way to help eliminate or dampen these loping or bouncing movements is to provide a ride control arrangement that includes an accumulator that is selectively connected to the one or more actuators operating the linkage associated with the work implement. When connected, the accumulator absorbs pressure fluctuations in the actuators thereby offsetting the changing forces that would otherwise be acting on the machine and causing the loping or bouncing. With such arrangements, a hydraulic circuit is provided that attempts to maintain a pre-charge in the accumulator equal to the pressure in the loaded end of the actuator. One example of such a ride control arrangement is disclosed in U.S. Pat. No. 6,321,534.

An issue with these systems is that the hydraulic circuit controlling the ride control system lacks any mechanism for controlling the pressure or flow of hydraulic fluid to the accumulator. As a result, during high hydraulic flow conditions such as can be encountered at the start of a dig cycle, a majority of the hydraulic fluid exiting the pump is directed to the accumulator and not to the actuators operating the work implement. This can lead to the accumulator being charged up to the maximum system pressure. However, the typical carrying load of the machine requires much less pressure in the hydraulic cylinders than the maximum system pressure. Accordingly, to match the accumulator pressure to the actuator pressure, hydraulic fluid must be wastefully drained from the accumulator to a tank. Moreover, when the accumulator is charged to a pressure that is higher than the pressure in the head end of the actuator and the machine encounters a bump or other obstacle, pressure can be directed to the head end of the actuator causing the work implement linkage driven by the actuator to jump undesirably.

### SUMMARY

In one aspect, the disclosure describes a hydraulic system including a hydraulic actuator having a first chamber. A pump is configured to supply pressurized fluid to the hydraulic actuator. A balancing valve is disposed between the pump and an accumulator and between the pump and the hydraulic actuator. The balancing valve is configured to be operable in a balancing mode to substantially equalize pressure in the accumulator and the first chamber of the hydraulic actuator and in a charging mode to direct pressurized fluid from the pump towards the accumulator. An activation valve is disposed between the balancing valve and the accumulator and between the accumulator and the hydraulic actuator. The activation valve is configured to be operable in a ride control mode to place the first chamber of the hydraulic actuator in communication with the accumulator and in a charging mode to direct pressurized fluid from the balancing valve to the accumulator. A flow control valve is disposed between the pump and the balancing valve and configured to block flow from the pump to the balancing valve when a flow rate from the pump exceeds a predetermined amount.

In another aspect, the disclosure describes a hydraulic system including a hydraulic actuator having a first chamber and a second chamber. A pump configured to supply pressurized fluid to the hydraulic actuator. A balancing valve is disposed between the pump and an accumulator and between the pump and the hydraulic actuator. The balancing valve is configured to be operable in a balancing mode to substantially equalize pressure in the accumulator and the first chamber of the hydraulic actuator and in a charging mode to direct pressurized fluid from the pump towards the accumulator. An activation valve is disposed between the balancing valve and the accumulator and between the accumulator and the first chamber of the hydraulic actuator. The activation valve is configured to be operable in a ride control mode to place the first chamber of the hydraulic actuator in communication with the accumulator and the second chamber of the hydraulic actuator in communication with a tank and operable in a charging mode to direct pressurized fluid from the balancing valve to the accumulator. A flow control valve is disposed between the pump and the balancing valve. The flow control valve is configured to move between a first position in which flow is permitted between the pump and the balancing valve and second position in which flow is blocked between the pump and the balancing valve. The flow control valve is configured to move from the first position to the second position pressure when a pressure at a location between the flow control valve and the balancing valve exceeds a pressure at a location downstream of the balancing valve by a predetermined amount. A charge pressure limiter valve is configured to be in fluid communication with the accumulator at a location downstream of the balancing valve and configured to move the flow control valve from the first position to the second position when pressure in the accumulator exceeds a predetermined amount.

In yet another aspect, the disclosure describes a method of controlling flow of pressurized fluid between a tank, a pump, a hydraulic actuator having a first chamber and a second chamber, and an accumulator. The method includes the step of directing pressurized fluid from the pump to the accumulator by operating a balancing valve in a charging mode and by operating an activation valve in a charging mode. The balancing valve is disposed between the pump and the accumulator and between the pump and the hydraulic actuator. The activation valve is disposed between the balancing valve and the accumulator and between the accumulator and the first chamber of the hydraulic actuator. Flow between the pump and the balancing valve is blocked with a flow control valve when a pressure at a location between the flow control valve and the balancing valve exceeds a pressure at a location downstream of the balancing valve by a predetermined amount. Pressure in the accumulator and the first chamber of the hydraulic actuator is substantially equalized by operating the balancing valve in a balancing mode. The first chamber of the hydraulic actuator is placed in communication with the accumulator and the second chamber of the hydraulic actuator in communication with the tank by operating the activation valve in a ride control mode.

### BRIEF DESCRIPTION OF THE DRAWINGS

FIG. 1 is a schematic side view of a machine suitable for use with the system and method according to the present disclosure.

FIG. 2 is a schematic illustration of an exemplary hydraulic ride control system according to the present disclosure.

### DETAILED DESCRIPTION

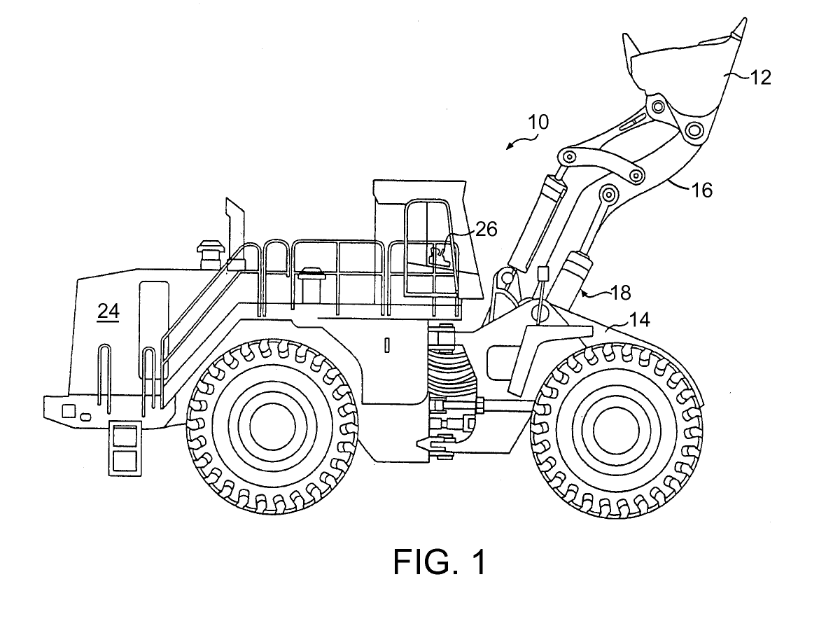

FIG. 1 illustrates an exemplary machine 10. The machine 10 may be any type of mobile machine that includes a movable implement that can be used to lift and carry a load. The machine may be associated with an industry such as mining, construction, farming, transportation, or any other industry known in the art. For example, the machine 10 may be an earth moving machine such as a loader, a dozer or an excavator. In the illustrated embodiment, the machine 10 comprises a wheel loader and the movable implement comprises a bucket 12 supported on a frame 14 by a linkage 16.

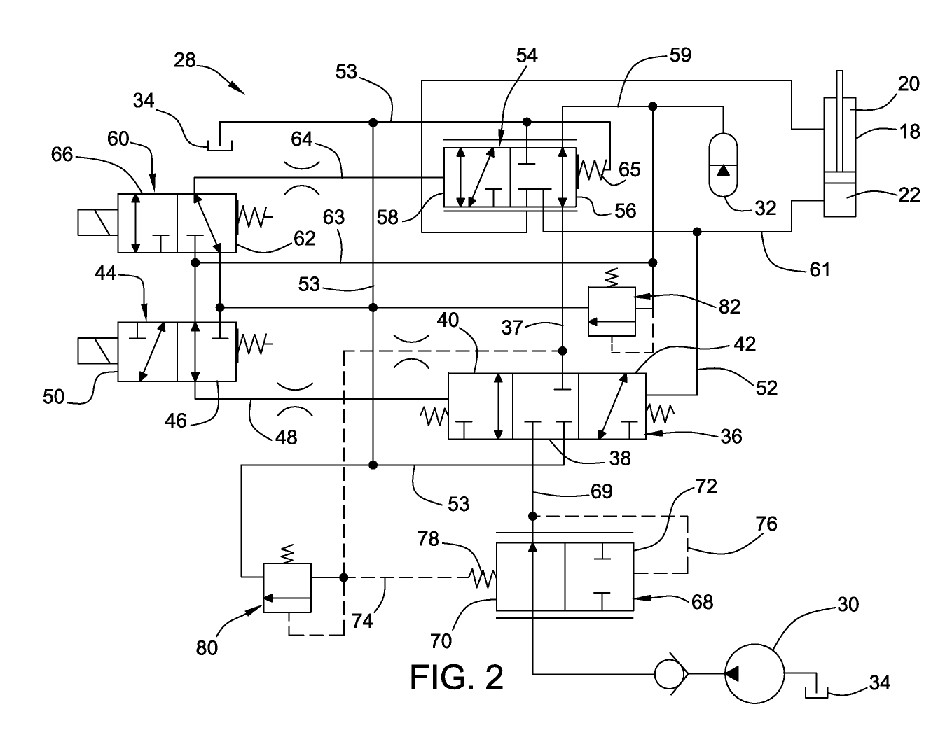

The movable implement may be any device that can be used to lift and/or carry a load such as, for example, a bucket, a shovel, a fork arrangement or any other suitable device known in the art. Moreover, the movable implement may be supported on the frame 14 of the machine 10 by any suitable linkage and include at least one hydraulic actuator 18 that may be configured to operate the linkage supporting the implement. The actuator 18 may include a rod end chamber 20 and a head end chamber 22 (shown schematically in FIG. 2) and be operable in a conventional manner to extend and retract in response to pressurized hydraulic fluid being selectively directed into and out of the chambers thereof. The actuator 18 may be configured and oriented such that the head end chamber 22 of the actuator is the loaded end of the actuator when the work implement, in this case the bucket 12, is carrying a load.

The machine 10 may be provided with a power source 24 such as, for example, a diesel engine, a gasoline engine, a gaseous fuel-powered engine such as a natural gas engine, or any other type of engine known in the art. It is contemplated that power source 24 may alternatively embody another source of power such as a fuel cell, a power storage device, an electric or hydraulic motor, or another source of power known in the art.

An operator interface device 26 may be provided and configured to receive input from a machine operator indicative of a desired machine or implement movement. The operator interface device 26 may embody, for example, a single- or multi-axis joystick located to one side of an operator station. The operator interface device 26 may be a proportional-type controller configured to position and/or orient the bucket 12. It is contemplated that additional and/or different operator interface devices may be included within operator interface such as, for example, wheels, knobs, push-pull devices, switches, buttons, pedals, and other operator interface devices known in the art.

As illustrated in FIG. 2, work machine 10 may include a hydraulic system, more particularly a hydraulic ride control system 28, that is configured to control the flow of hydraulic fluid between a pump 30, an accumulator 32 and the hydraulic actuator 18. While the illustrated system only includes a single hydraulic actuator 18, it will be understood that the system may include multiple hydraulic actuators in the place of the single actuator 18 of FIG. 2. Likewise, while only a single accumulator 32 is shown in FIG. 2, an arrangement with multiple accumulators could be used in place of the single accumulator. The illustrated hydraulic system 28 may further include a tank 34. The tank 34 may include a source of low pressure hydraulic fluid, such as, for example, a fluid reservoir. The fluid may include a dedicated hydraulic oil, an engine lubrication oil, a transmission lubrication oil, or other suitable working fluid. Although only a single tank 34 is shown, it is also contemplated that the hydraulic ride control system 28 may be in fluid communication with multiple, separate fluid tanks.

The pump 30 may be any type of pump that can be configured to produce a flow of pressurized hydraulic fluid and may include, for example, a piston pump, gear pump, vane pump, or gerotor pump. The pump 30 may have a variable displacement capacity, or, in the alternative, a fixed capacity for supplying the flow. In operation, the pump 30 may draw hydraulic fluid from a source of hydraulic fluid, such as the tank 34, through a pump inlet at ambient or low pressure and may work the hydraulic fluid to pressurize it. The pressurized hydraulic fluid flow may exit through the pump outlet. The pump 30 may be drivably connected to the power source 24 of the machine by a countershaft, a belt, an electrical circuit, and/or in any other suitable manner. The pump 30 may be dedicated to supplying pressurized hydraulic fluid only to the hydraulic ride control system 28, or alternatively, the pump 30 may also supply pressurized hydraulic fluid additional hydraulic systems of the machine 10.

For selectively balancing the pressure of the hydraulic fluid in the accumulator 32 with the pressure of the hydraulic fluid in the head end chamber 22 of the actuator 18, the hydraulic ride control system 28 may include a balancing valve 36 that may be disposed between the pump 30 and the accumulator 32. The balancing valve 36 may be configured to be movable to a balancing mode to equalize pressure in the accumulator 32 and the head end chamber 22 of the hydraulic actuator 18, which may be subject to pressure when the bucket 12 is carrying a load. The balancing valve 36 may further be configured to be movable to a charging mode in which the balancing valve directs pressurized fluid from the pump 30 towards the accumulator 32 (for example, via line 37). The balancing valve 36 may be a three-position spool valve that includes a first neutral position 38 in which flow to and from the accumulator 32 through the balancing valve 36 is blocked. The balancing valve 36 may further include a second position 40 in which the line 37 to the accumulator 32 is placed in communication with the tank 34 (for example, via line 53) for venting pressure from the accumulator 32 and a third position 42 in which pressurized fluid from the pump 30 is directed towards the accumulator 32 (for example via line 37).

The hydraulic ride control system 28 may further include a balancing control valve 44 that may be configured to switch the balancing valve 36 between the balancing mode and its charging mode. The balancing control valve 44 may include a two-position solenoid valve having a first position 46 in which a first pilot line 48 of the balancing valve 36 is in communication with the accumulator 32 and a second position 50 in which the first pilot line 48 is in communication with the tank 34. The balancing valve 36 may further include a second pilot line 52 in communication with the head end chamber 22 of the actuator 18.

With this configuration, the first position 46 may define the balancing mode in that first and second pilot lines 48, 52 may be charged with accumulator pressure and head end chamber pressure and differences in that pressure may cause the balancing valve 36 to move between the first, second and third positions 38, 40 and 42. For example, if the pressure in the accumulator 32 is less than the pressure in the head end chamber 22, the balancing valve 36 will move to the third position 42 in which pressurized fluid from the pump 30 is directed towards the accumulator 32 (for example, via line 37) to further charge the accumulator with pressure. Conversely, if the pressure in the accumulator 32 is higher than the pressure in the head end chamber 22, the balancing valve 36 will move to the second position 40 in which pressure from the accumulator 32 is vented to the tank 34 (for example, via line 53. Once the pressure in the accumulator 32 equalizes with the pressure in the head end chamber 22 of the actuator 18, the balancing valve 36 moves to the first position 38 in which flow into and out of the accumulator 32 is blocked. When the balancing control valve 44 is in the second position 50, the balancing valve 36 is moved by the pressure in the second pilot line 52 into the third position 42 due to the absence of pressure in the first pilot line 48. In this position, pressurized fluid may bypass the actuator 18 and be directed exclusively towards the accumulator 32 in order to charge the accumulator with pressurized fluid. Those skilled in the art will appreciate that methods other than a balancing control valve may be used to switch the balancing valve between the balancing and charging modes including, for example, direct electro and/or hydraulic control of the balancing valve.

For selectively placing the accumulator 32 in communication with the head end chamber 22 of the actuator 18, the hydraulic ride control system 28 may include an activation valve 54. The activation valve 54 may be disposed between the balancing valve 36 and the accumulator 32 and be configured to be movable to a ride control mode in which the accumulator 32 is in communication with the head end chamber 22 of the actuator and the rod end chamber 20 of the actuator is in communication with the tank 34. The activation valve 54 may also be configured to be movable to a charging mode in which the accumulator 32 is in communication with the balancing valve 36. Accordingly, when both the activation valve 54 and the balancing valve 36 are in the charging mode, the accumulator 32 is in fluid communication with the pump 30. The activation valve 54 may be a two position valve including a first position 56, defining the charging mode, in which the outlet side of the balancing valve 36 (e.g., line 37) is connected to the accumulator 32 (e.g., via line 59) and a second position 58, defining a ride control mode, in which the accumulator 32 (e.g., and line 59) is connected to the head end chamber 22 of the actuator 18 (e.g., via line 61) and the rod end chamber 20 of the actuator is in communication with the tank 34 (e.g., via line 53).

The hydraulic ride control system 28 may further include an activation control valve 60 that may be configured to switch the activation valve 54 between its ride control mode and its charging mode. The activation control valve 60 may include a two-position solenoid valve having a first position 62 in which a first pilot line 64 of the activation valve 54 is connected to the tank 34 (e.g., via line 53). When in this position, the activation valve 54 moves to its charging mode or first position under the force of a spring 65. The activation control valve 60 also has a second position 66 in which the first pilot line 64 of the activation valve 54 is in communication with the accumulator 32 (e.g., via line 63). In this position, the pressure from the accumulator 32 in the first pilot line 64 causes the activation valve 54 to move to the ride control mode or second position 58, thereby placing the accumulator 32 in communication with the loaded or head end chamber 22 of the actuator 18 (e.g., connecting lines 59 and 61). Those skilled in the art will appreciate that other methods may be used to switch the activation valve between the ride control and charging modes including, for example, direct electro and/or hydraulic control of the activation valve.

For controlling the flow of hydraulic fluid into the hydraulic ride control system 18 and thus to the accumulator 32, a flow control valve 68, such as, for example, a pre-compensator valve, may be provided downstream from the pump 30. The flow control valve 68 may be a two-position valve including a first position 70 in which flow is permitted downstream of the flow control valve 68 to the balancing valve 36 (e.g., via line 69) and the remainder of the hydraulic ride control system 28 and a second position 72 in which fluid is blocked from reaching the balancing valve 36 and the remainder of the hydraulic ride control system 28. The flow control valve 68 may be configured to move from the first position 70 to the second position 72 when a pressure at a location (e.g., in line 69) between the flow control valve 68 and the balancing valve 36 exceeds a pressure at a location downstream of the balancing valve 36 (e.g., in line 37). To this end, the flow control valve 68 may have an associated first pilot line 74 that communicates with the hydraulic ride control system 28 at a point (e.g., in line 37) just downstream of the exit of the balancing valve 36 and a second pilot line 76 that communicates with a point (e.g., in line 69) just downstream of the flow control valve 68. The flow control valve 68 may further include a spring 78 that acts with the first pilot line 74 to urge the valve to the first position 70. With the illustrated configuration, the flow control valve 68 moves from the first position 70 to the second position 72 to shut off the flow of fluid to the balancing valve 36 and the accumulator 32 when the pump 30 is being called upon to produce high flow and high pressure such as during the start of a work cycle in which the implement is going to be used, such as, for example, to dig into a pile of dirt. In such cases, all of the flow of hydraulic fluid may be directed to the actuator to operate the implement without any hydraulic fluid being diverted to the accumulator 32.

For limiting the charge pressure of the accumulator 32 to a predetermined amount, the hydraulic ride control system 28 may include charge pressure limiter valve 80. The charge pressure limiter valve 80 may be configured as a pressure relief valve that is in communication with the accumulator 32 at a location (e.g., in line 37) downstream of the balancing valve 36. Further, the charge pressure limiter valve 80 may be configured to move the flow control valve 68 from the first position 70 to the second position 72, thereby blocking the flow of pressurized fluid from the pump 32 to the balancing valve 36 and into the ride control system, when the pressure in the accumulator 32 exceeds a predetermined amount. More specifically, the charge pressure limiter valve 80 may be disposed in the first pilot line 74 to the flow control valve 68 such that when the pressure limiter valve 80 opens it vents the first pilot line 74 to tank 34 (e.g., via line 53) causing the flow control valve 68 to move to the second position 72 as a result of pressure in the second pilot line 76. Thus, by setting the pressure limiter valve 80 to open at an appropriate pressure, the pressure limiter valve may help prevent the accumulator 32 from being charged to too high of a pressure when the balancing valve 36 and activation valve 54 are in the charging mode.

The hydraulic ride control system 28 may be provided with an additional accumulator relief valve 82 which may provide a back-up to the charge pressure limiter valve 80 and allow for the use of accumulators rated for relatively lower pressures. The additional accumulator relief valve 82 may be arranged so as to be in communication with the accumulator 32 at a position downstream of the activation valve 54. In this position, the additional accumulator relief valve 82 is arranged so that it can open and relieve pressure in the system and thereby protect the accumulator 32 from overcharging even if the charge pressure limiter valve 80 is not functioning for some reason. This added protection can allow for the use of relatively lower capacity accumulators, which may reduce the overall cost of the hydraulic ride control system.

### INDUSTRIAL APPLICABILITY

This disclosure generally relates to a hydraulic ride control system that may be used to help eliminate or dampen loping or bouncing movements when a machine moves over rough or uneven terrain or other obstacles while holding a load with a work implement that is operated by a hydraulic cylinder. The present disclosure is applicable to hydraulic systems in any machine that may be called upon to move when using an implement to carry a load. The hydraulic ride control system 28 of the present disclosure may provide increased inefficiency in that, during high flow or high pressure conditions such as encountered at the beginning of a dig cycle, the system cuts off flow to the accumulator 32 thereby allowing more of the flow produced by the pump to be directed towards the actuator 18 or actuators manipulating the implement where it is needed most immediately. This may help prevent the need to later drain off excess pressure from the accumulator 32 to the tank 34 in order to balance the pressure in the accumulator with the pressure in the loaded, head end chamber 22 of the actuator. The charging mode also enables the accumulator 32 to be charged independent of what may be occurring with respect to the actuator 18.

In operation, the system may typically operate in the charging mode with the activation control valve 60 in the first position 62 (causing the activation valve to move to its first position 56) and the balancing control valve 44 in the second position 50 (causing the balancing valve 36 to move to its third position 42). In charging mode, the accumulator 32 is charged up to a relatively high pressure, which is limited by the setting of the accumulator relief valve 82. Then, when machine conditions warrant activation of the ride control mode, such as for example when the machine ground speed exceeds a predetermined value, the balancing control valve 44 will move to the first position 46 actuating the balancing mode of the balancing valve 36 and thereby permitting the balancing valve 36 to move between its first, second and third positions 38, 40, 42 as necessary to balance the pressures in the accumulator 32 and the head end chamber of the actuator 18. The balancing valve 36 may stay in the balancing mode for a predetermined amount of time. When that predetermined amount of time passes, the activation control valve 60 may move to the second position 66 thereby actuating the activation valve 54 to the ride control mode (its second position 58) wherein the accumulator 32 is in communication with the head end chamber 22 of the actuator 18.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

I claim:

1. A hydraulic system comprising:
a hydraulic actuator having a first chamber;
a pump configured to supply pressurized fluid to the hydraulic actuator;
an accumulator;
a balancing valve disposed between the pump and the accumulator and between the pump and the hydraulic actuator, the balancing valve being configured to be operable in a balancing mode to substantially equalize pressure in the accumulator and the first chamber of the hydraulic actuator and in a charging mode to direct pressurized fluid from the pump towards the accumulator;
an activation valve disposed between the balancing valve and the accumulator and between the accumulator and the hydraulic actuator, the activation valve being configured to be operable in a ride control mode to place the first chamber of the hydraulic actuator in communication with the accumulator and in a charging mode to direct pressurized fluid from the balancing valve to the accumulator; and
a flow control valve disposed between the pump and the balancing valve and configured to block flow from the pump to the balancing valve when a flow rate from the pump exceeds a predetermined amount.

2. The hydraulic system of claim 1 wherein the balancing valve includes a first position in which flow to and from the accumulator is blocked, a second position in which the accumulator is placed in communication with a tank, and a third position in which the pump is in communication with the accumulator.

3. The hydraulic system of claim 2 further including a balancing control valve configured to switch the balancing valve between the balancing mode and the charging mode, wherein the balancing control valve includes a first position in which a first pilot line of the balancing valve is in communication with the accumulator and second position in which the first pilot line is in communication with a tank.

4. The hydraulic system of claim 3 wherein the balancing control valve comprises a solenoid valve.

5. The hydraulic system of claim 1 wherein the activation valve includes a first position in which an outlet side of the balancing valve is in communication with the accumulator and a second position in which the accumulator is in communication with the first chamber of the hydraulic actuator and a second chamber of the hydraulic actuator is in communication with a tank.

6. The hydraulic system of claim 5 further including an activation control valve configured to switch the activation valve between the ride control mode and the charging mode, wherein the activation control valve includes a first position in which a first pilot line of the activation valve is in communication with a tank and a second position in which the first pilot line of the activation valve is in communication with the accumulator.

7. The hydraulic system of claim 1 further including a charge pressure limiter valve configured to direct the flow control valve to block flow from the pump when pressure in the accumulator exceeds a predetermined amount.

8. The hydraulic system of claim 1 further including an accumulator relief valve arranged to be in communication with the accumulator at a location downstream of the activation valve and be operable to relieve pressure to a tank when pressure in the accumulator exceeds a predetermined amount.

9. A hydraulic system comprising:
a hydraulic actuator having a first chamber and a second chamber;
a pump configured to supply pressurized fluid to the hydraulic actuator;
a tank;
an accumulator;
a balancing valve disposed between the pump and the accumulator and between the pump and the hydraulic actuator, the balancing valve being configured to be operable in a balancing mode to substantially equalize pressure in the accumulator and the first chamber of the hydraulic actuator and in a charging mode to direct pressurized fluid from the pump towards the accumulator;
an activation valve disposed between the balancing valve and the accumulator and between the accumulator and the first chamber of the hydraulic actuator, the activation valve being configured to be operable in a ride control mode to place the first chamber of the hydraulic actuator in communication with the accumulator and the second chamber of the hydraulic actuator in communication with the tank and operable in a charging mode to direct pressurized fluid from the balancing valve to the accumulator;
a flow control valve disposed between the pump and the balancing valve and being configured to move between a first position in which flow is permitted between the pump and the balancing valve and second position in which flow is blocked between the pump and the balancing valve, the flow control valve being configured to move from the first position to the second position pressure when a pressure at a location between the flow control valve and the balancing valve exceeds a pressure at a location downstream of the balancing valve by a predetermined amount; and
a charge pressure limiter valve configured to be in fluid communication with the accumulator at a location downstream of the balancing valve and configured to move the flow control valve from the first position to the second position when pressure in the accumulator exceeds a predetermined amount.

10. The hydraulic system of claim 9 wherein the balancing valve includes a first position in which flow to and from the accumulator is blocked, a second position in which the accumulator is placed in communication with the tank, and a third position in which the pump is in communication with the accumulator.

11. The hydraulic system of claim 10 further including a balancing control valve configured to switch the balancing between the balancing mode and the charging mode, wherein the balancing control valve includes a first position in which a first pilot line of the balancing valve is in communication with the accumulator and second position in which the first pilot line is in communication with the tank.

12. The hydraulic system of claim 11 wherein the balancing control valve comprises a solenoid valve.

13. The hydraulic system of claim 9 wherein the activation valve includes a first position in which an outlet side of the balancing valve is in communication with the accumulator and a second position in which the accumulator is in communication with the first chamber of the hydraulic actuator and the second chamber of the hydraulic actuator is in communication with the tank.

14. The hydraulic system of claim 13 further including an activation control valve configured to switch the activation valve between the ride control mode and the charging mode, wherein the activation control valve includes a first position in which a first pilot line of the activation valve is in communication with the tank and a second position in which the first pilot line of the activation valve is in communication with the accumulator.

15. The hydraulic system of claim 14 wherein the activation control valve comprises a solenoid valve.

16. The hydraulic system of claim 8 further including an accumulator relief valve arranged to be in communication with the accumulator at a location downstream of the activation valve and be operable to relieve pressure to the tank when pressure in the accumulator exceeds a predetermined amount.

17. A method of controlling flow of pressurized fluid between a tank, a pump, a hydraulic actuator having a first chamber and a second chamber, and an accumulator, the method comprising the steps of:
directing pressurized fluid from the pump to the accumulator by operating a balancing valve in a charging mode and by operating an activation valve in a charging mode, the balancing valve being disposed between the pump and the accumulator and between the pump and the hydraulic actuator, the activation valve being disposed between the balancing valve and the accumulator and between the accumulator and the first chamber of the hydraulic actuator;
blocking flow between the pump and the balancing valve with a flow control valve when a pressure at a location between the flow control valve and the balancing valve exceeds a pressure at a location downstream of the balancing valve by a predetermined amount;
substantially equalizing pressure in the accumulator and the first chamber of the hydraulic actuator by operating the balancing valve in a balancing mode; and
placing the first chamber of the hydraulic actuator in communication with the accumulator and the second chamber of the hydraulic actuator in communication with the tank by operating the activation valve in a ride control mode.

18. The method of claim 17 further including the step of directing the flow control valve to block flow between the pump and the balancing valve with a charge pressure limiter valve when pressure in the accumulator exceeds a predetermined amount.

19. The method of claim 17 wherein the balancing valve includes a first position in which flow to and from the accumulator is blocked, a second position in which the accumulator is placed in communication with the tank, and a third position in which the pump is in communication with the accumulator.

20. The method of claim 17 further the step of relieving pressure in the accumulator when pressure in the accumulator exceeds a predetermined amount using an accumulator relief valve arranged to be in communication with the accumulator at a location downstream of the activation valve.
